(19) United States
(12) Patent Application Publication
(10) Pub. No.: US 2026/0294084 A1
(43) Pub. Date: Oct. 1, 2026

(54) ELECTRIC TOOTHBRUSH

(71) Applicant: CIXI SEAGO ELECTRONICS CO., LTD, Cixi (CN)

(72) Inventors: Yanzhong Cai, Cixi (CN); Weibing Peng, Cixi (CN); Yuli Wang, Cixi (CN)

(21) Appl. No.: 19/315,476

(22) Filed: Aug. 29, 2025

(30) Foreign Application Priority Data
Mar. 28, 2025 (CN) 202520576867.5

(51) Int. Cl. A46B 5/00; A46B 13/00; A46B 13/02; A61C 17/22; A61C 17/34

(52) U.S. Cl. CPC A46B 5/0095; A46B 13/008; A46B 13/023; A61C 17/225; A61C 17/3436; A61C 17/3481; A61C 2204/005

(57) ABSTRACT

An electric toothbrush includes a toothbrush handle and toothbrush heads. A tenon protrudes from end of toothbrush handle, and the tenon includes a first support section and a second support section. The second support section surrounds base end of the first support section, and the first support section can move relative to the second support section. A motor for driving the first support section to move is provided inside the toothbrush handle. The toothbrush heads include a vibrating toothbrush head and a rotating toothbrush head. The first support section can be assembled with the vibrating toothbrush head, so that the motor can drive the vibrating toothbrush head to vibrate via the first support section. The first support section and the second support section can be assembled with the rotating toothbrush head, so that the motor can drive bristles of the rotating toothbrush head to rotate via the first support section.

### CROSS-REFERENCE TO RELATED APPLICATIONS

The present disclosure claims the priority to the Chinese patent application No. 202520576867.5 filed with the Chinese Patent Office on Mar. 28, 2025, and entitled “ELECTRIC TOOTHBRUSH”, the contents of which are incorporated herein by reference in entirety.

### TECHNICAL FIELD

The present disclosure relates to the field of electric toothbrushes, and in particular, to an electric toothbrush.

### BACKGROUND ART

Different electric toothbrushes have different functional principles, and vibrating electric toothbrushes and rotating electric toothbrushes are two major categories of electric toothbrushes with mutually different functional principles. A vibrating electric toothbrush mainly relies on high-frequency vibrations to drive a toothbrush head to swing at a high speed, and a rotating electric toothbrush mainly relies on a motor to drive a circular brush head to rotate. Motors corresponding to these two major categories of electric toothbrushes output different forms of motion.

CN116348062A discloses a personal care system and method. A personal care appliance includes a motor with a drive shaft. In response to a voltage signal, the drive shaft oscillates with an oscillatory motion having an oscillation amplitude. A control circuit includes a user interface, a processor, a pulse width modulation signal generator, and a power supply that operate in cooperation. The control circuit supplies the voltage signal to the motor, and the voltage signal has a frequency and a duty cycle. The control circuit changes the frequency and the duty cycle of the voltage signal in response to an oscillation adjustment input received from the user interface, so that the oscillation amplitude of the drive shaft changes along a substantially linear rate-of-change curve with respect to the frequency. The objective of CN116348062A is to provide an electric toothbrush with oscillatory motion that can be smoothly and continuously adjusted from an intensity to another intensity without steps or jumps in oscillation. CN116348062A does not integrate a vibrating electric toothbrush and a rotating electric toothbrush.

CN208319355U discloses an electric toothbrush with alternating vibration modes. The electric toothbrush with alternating vibration modes includes a brush handle and a toothbrush head. A controller and a motor are provided in the brush handle. The toothbrush head is connected to the motor, and the motor drives the toothbrush head to rotate and vibrate or linearly vibrate in different time periods under a control of the controller. The toothbrush head is able to perform a linear vibration or a rotational vibration under a drive of the motor. Moreover, the toothbrush head is able to switch from the linear vibration to the rotational vibration or from the rotational vibration to the linear vibration under an action of the controller.

The motor used in CN208319355U is a drive motor capable of respectively outputting the rotational vibration or the linear vibration. The motor can respectively drive the toothbrush head to rotate and vibrate or linearly vibrate in different time periods under the control of the controller. The motor and the toothbrush head are connected through a mode switching mechanism. The mode switching mechanism is electrically connected to the controller, and the mode switching mechanism is used to switch the toothbrush head between the two modes of linear vibration and rotational vibration under the control of the controller. Usually, a vibrating toothbrush head and a rotating toothbrush head have different structures, and CN208319355U does not disclose or suggest the switching of toothbrush heads.

CN210044170U discloses an electric toothbrush. The electric toothbrush includes: a body; a brush head; a brush rod; and a brush handle connected to another end of the brush rod and having a first accommodating space inside. The brush handle includes: a bracket; a motor fixed to the bracket through a connector and including a first oscillator and a second oscillator; a control circuit board connected to the motor and including a first circuit and a second circuit, where the first circuit controls the first oscillator, and the second circuit controls the second oscillator; and a vibration transmission shaft through which the brush head is drove to vibrate. The electric toothbrush has two vibration modes, in which a first vibration mode is an axial reciprocating mode, and a second vibration mode is an axial rotational mode. The motor used in the electric toothbrush is a dual-core motor.

Similar to CN208319355U, CN210044170U does not disclose or suggest the switching of toothbrush heads.

### SUMMARY

In view of the above state of the prior art, the present disclosure is made. The object of the present disclosure is to provide an electric toothbrush.

An electric toothbrush according to an embodiment of the present disclosure comprises:
a toothbrush handle, where a tenon protrudes from an end of the toothbrush handle, and the tenon comprises a first support section and a second support section; the second support section surrounds a base end of the first support section, and the first support section is able to move relative to the second support section; and a motor for driving the first support section to move is provided inside the toothbrush handle; and
toothbrush heads comprising a vibrating toothbrush head and a rotating toothbrush head, where the first support section is able to be assembled with the vibrating toothbrush head, so that the motor is able to drive the vibrating toothbrush head to vibrate via the first support section; and the first support section and the second support section are able to be assembled with the rotating toothbrush head, so that the motor is able to drive bristles of the rotating toothbrush head to rotate via the first support section.

In at least one embodiment, the first support section is able to be in interference fit and/or snap fit with the vibrating toothbrush head and the rotating toothbrush head; and/or
the second support section is able to be in clearance fit with the vibrating toothbrush head, and to be in interference fit and/or snap fit with the rotating toothbrush head.

In at least one embodiment, the rotating toothbrush head comprises a brush rod shell and a circular brush head, a connecting rod is comprised inside the brush rod shell, and the connecting rod and the circular brush head form a crank-rocker mechanism.

In at least one embodiment, the first support section is closer to a top end of the toothbrush handle than the second support section; and
the second support section has a through hole for the first support section to movably pass through, and an inner diameter of the through hole is greater than an outer diameter of the first support section.

In at least one embodiment, the vibrating toothbrush head is able to vibrate in a transverse direction of the electric toothbrush. When the first support section is assembled with the vibrating toothbrush head, at least a gap is arranged in the transverse direction between the second support section and the vibrating toothbrush head.

In at least one embodiment, the first support section comprises a flattened section, an outer wall of the flattened section comprises a convex curved surface and a flattened plane, and the flattened plane is parallel to a length direction of the first support section; and
a female buckle for snap-fitting with the vibrating toothbrush head or the rotating toothbrush head is recessed on the convex curved surface.

In at least one embodiment, a sleeve is arranged between the first support section and the vibrating toothbrush head, an outer wall of the sleeve has a convex rib, and a length direction of the convex rib is parallel to an axial direction of the sleeve. The convex rib has a protrusion, and a top end of the protrusion is in interference fit with the vibrating toothbrush head.

In at least one embodiment, the sleeve has an assembly hole for the first support section to enter, a first male buckle protrudes from an inner wall of the assembly hole, and the first male buckle is able to be snap-fitted with the female buckle; and
a sloping platform further protrudes from the inner wall of the assembly hole, and the sloping platform is able to be in contact with the flattened plane.

In at least one embodiment, an outer wall of the second support section comprises a plurality of abutting portions protruding outward, the abutting portions are arranged in mirror symmetry or in a circular array around a central line of the second support section, and the abutting portions are in interference fit with the rotating toothbrush head.

In at least one embodiment, the connecting rod comprises a second male buckle, and the second male buckle is able to be snap-fitted with the female buckle.

In at least one embodiment, an identification point is provided on the tenon, and the identification point is able to identify and distinguish whether the tenon is assembled with the vibrating toothbrush head or the rotating toothbrush head. The identification point uses physical contact point identification, circuit connection identification, radio frequency tag identification, optical identification or near field communication identification.

Beneficial effects of the electric toothbrush of the present disclosure include the following. The toothbrush handle can be assembled with two types of toothbrush heads, namely the vibrating toothbrush head and the rotating toothbrush head, which is convenient for the two toothbrush heads to work in respective working modes. By only replacing the vibrating toothbrush head or the rotating toothbrush head, the working mode of the electric toothbrush can be changed, so as to achieve two types (a vibrating type and a rotating type) of electric toothbrushes with different working principles and different cleaning effects.

Different toothbrush heads are assembled with different portions of the tenon, which is convenient for targeted positional limitation and functional distinction. The first support section can be directly assembled with the vibrating toothbrush head to directly transmit the vibration of the first support section to the vibrating toothbrush head. Both the first support section and the second support section are assembled with the rotating toothbrush head, which is convenient for driving the bristles of the rotating toothbrush head to rotate.

By using a toothbrush handle and two toothbrush heads, the vibration or rotation function can be switched according to personal needs and oral conditions to find a cleaning method suitable for a user. There is no need to purchase two separate electric toothbrushes, which saves the purchase cost, saves the space and improves the portability.

### BRIEF DESCRIPTION OF DRAWINGS

To more clearly illustrate the technical solutions in the embodiments, the drawings in the embodiments will be briefly introduced below. Obviously, the drawings described below are only some embodiments of the present disclosure, and other drawings can also be obtained by those of ordinary skill in the art without inventive efforts based on these drawings.

FIG. 1 is a side view of a toothbrush handle of an electric toothbrush according to an embodiment of the present disclosure;

FIG. 2 is a partial enlarged view of part A of the electric toothbrush in FIG. 1;

FIG. 3 is a partial perspective view of a toothbrush handle of an electric toothbrush according to an embodiment of the present disclosure;

FIG. 4 is a partial perspective view of a toothbrush handle of an electric toothbrush according to an embodiment of the present disclosure;

FIG. 5 is a partial perspective view of a toothbrush handle of an electric toothbrush according to an embodiment of the present disclosure;

FIG. 6 is a perspective view of a sleeve of an electric toothbrush according to an embodiment of the present disclosure;

FIG. 7 is a longitudinal sectional view of an electric toothbrush of the present disclosure in a first use state;

FIG. 8 is a partial enlarged view of part B of the electric toothbrush in FIG. 7;

FIG. 9 is a longitudinal sectional view of an electric toothbrush of the present disclosure in a second use state; and

FIG. 10 is a longitudinal sectional view of an electric toothbrush of the present disclosure in a second use state.

### EXPLANATION OF REFERENCE NUMERALS

1—bottom cover assembly; 2—battery; 3—PCB board; 4—light-shielding member; 5—motor; 6—handle housing; 7—vibrating toothbrush head; 8—rotating toothbrush head; 81—connecting rod; 82—circular brush head; 83—brush rod shell; 84—second male buckle; 85—positioning hole; 9—first support section; 91—flattened plane; 92—female buckle; 93—chamfer; 94—convex curved surface; 10—second support section; 101—inwardly contracting surface; 102—abutting portion; 104—third male buckle; 11—sleeve; 111—assembly hole; 112—convex rib; 113—protrusion; 114—window hole; 115—sloping platform; 116—first male buckle; 12—gap; 13—through hole.

### DETAILED DESCRIPTION OF EMBODIMENTS

The exemplary embodiments of the present disclosure are described below with reference to the drawings. It should be understood that these specific descriptions are only intended to teach those skilled in the art how to implement the present disclosure, rather than to enumerate all feasible ways of the present disclosure, nor to limit the scope of the present disclosure.

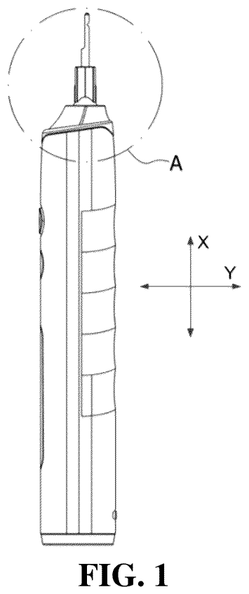

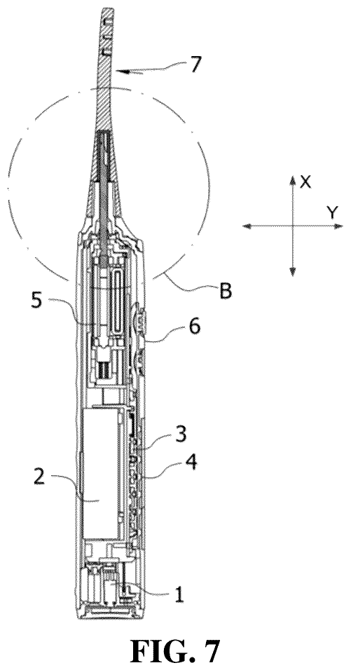

Hereinafter, a length direction of an electric toothbrush is referred to as a longitudinal direction or an axial direction, which corresponds to the X direction in the drawings. An extending direction of bristles of a toothbrush head is referred to as a frontward/rearward direction, which corresponds to the Y direction in the drawings. As can be seen from FIGS. 1 and 7, some operation buttons can be arranged on a front side of a toothbrush handle, and the front side can be a side where the bristles contact teeth. A direction of the electric toothbrush perpendicular to the above length direction and frontward/rearward direction is referred to as a transverse direction or a leftward/rightward direction, which is consistent with the Z direction in the drawings.

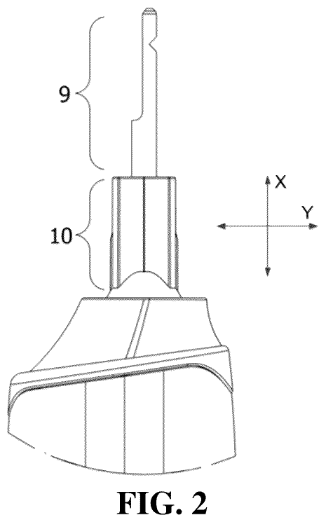

Referring to FIGS. 2, 3, 4, 7 and 9, an electric toothbrush is provided in an embodiment of the present disclosure. Particularly, the electric toothbrush can be a dual-purpose electric toothbrush for vibration and rotation. The electric toothbrush includes a toothbrush handle and toothbrush heads. FIG. 1 shows the complete toothbrush handle, and a tenon protrudes from an end of the toothbrush handle. As shown in FIG. 2, the tenon includes a first support section 9 and another section is a second support section 10. The toothbrush heads are replaceable and selectable. The toothbrush heads include a vibrating toothbrush head 7 and a rotating toothbrush head 8. The first support section 9 is correspondingly assembled with the vibrating toothbrush head 7, and the second support section 10 is correspondingly assembled with the rotating toothbrush head 8. As shown in FIG. 9, the rotating toothbrush head 8 at least includes a brush rod shell 83 and a circular brush head 82, and a connecting rod 81 is arranged inside the brush rod shell 83. The connecting rod 81 and the circular brush head 82 form a crank-rocker mechanism.

The first support section 9 can be assembled with the connecting rod inside the rotating toothbrush head 8, and the second support section 10 is assembled with the brush rod shell of the rotating toothbrush head 8. The crank-rocker mechanism converts a transverse swinging of the first support section 9 into a rotational motion of the circular brush head (bristles) of the rotating toothbrush head around its central axis. Moreover, a relative position between the second support section 10 and the brush rod shell of the rotating toothbrush head 8 remains unchanged, so that a normal operation of the crank-rocker mechanism can be ensured.

The second support section 10 surrounds a base end (a lower end in FIG. 2) of the first support section 9, and a front end of the first support section 9 is exposed from the second support section 10. The first support section 9 is able to move relative to the second support section 10.

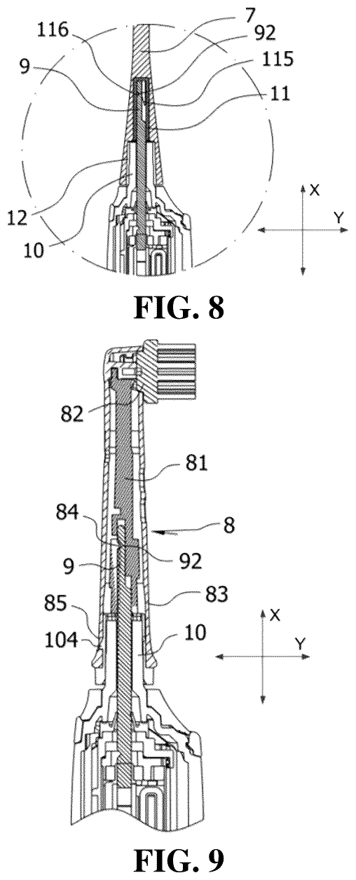

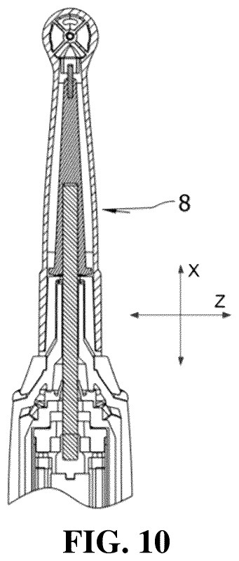

As shown in FIGS. 7 and 8, when the first support section 9 is assembled with the vibrating toothbrush head 7, the first support section 9 has a transverse (corresponding to the Z direction in the drawings) vibration degree of freedom relative to the second support section 10. A length direction (corresponding to the X direction in the drawings) of the electric toothbrush is a longitudinal direction, and the transverse direction in the transverse vibration degree of freedom here refers to a direction perpendicular to the longitudinal direction (corresponding to the X direction in the drawings) and a frontward/rearward direction (corresponding to the Y direction in the drawings). The transverse direction can also be called a leftward/rightward direction. As shown in FIGS. 9 and 10 in which a viewing angle of FIG. 10 is rotated by 90° compared with that of FIG. 9, when the second support section 10 is assembled with the rotating toothbrush head 8, the second support section 10 is assembled with and is positionally limited by the brush rod shell 83, the first support section 9 is assembled with and is positionally limited by the connecting rod 81, and the first support section 9 has the transverse vibration (or swinging) degree of freedom relative to the second support section 10. That is, whether the vibrating toothbrush head 7 or the rotating toothbrush head 8 is in operation, the first support section 9 moves relative to the second support section 10. The first support section 9 and the second support section 10 each have a simple and reliable structure, and are easy to be assembled with the vibrating toothbrush head 7 and the rotating toothbrush head 8, respectively.

In an embodiment, the first support section 9 is in interference fit or snap fit with the vibrating toothbrush head 7. The second support section 10 is in interference fit or snap fit with the rotating toothbrush head 8.

Whether an interference fit or a snap fit is selected, the main objective is to ensure that the vibrating toothbrush head 7 and the rotating toothbrush head 8 are able to be quickly disassembled and assembled with the tenon for replacement and fixation with positional limitation.

As shown in FIG. 2, in an embodiment, an entirety of the first support section 9 (or the front end of the first support section 9) is closer to a top end of the toothbrush handle (an end proximate to the toothbrush head) than the second support section 10. In other words, a longitudinal distance from the first support section 9 to a centroid of the toothbrush handle is greater than a longitudinal distance from the second support section 10 to the centroid of the toothbrush handle. That is, the second support section 10 is located at a root of the tenon, and the first support section 9 is located at a top of the tenon, i.e., the second support section 10 is located at a lower position than the first support section 9 in the longitudinal direction (corresponding to the X direction in the drawings). In addition, a transverse dimension and a front direction dimension of the second support section 10 are respectively greater than a transverse dimension and a front direction dimension of the first support section 9. In this way, the two different types of toothbrush heads are ensured to have respective dedicated mounting positions, and are ensured to be accurately mounted.

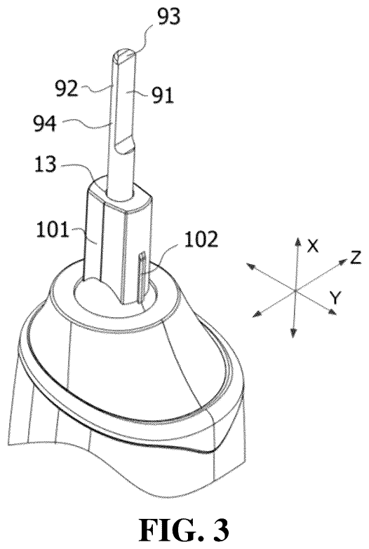

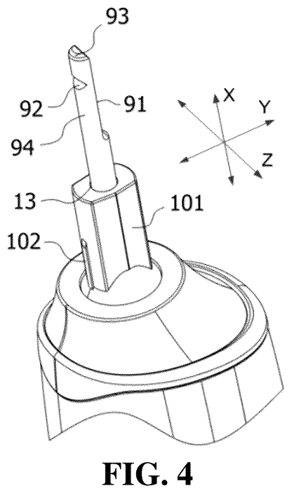

As shown in FIGS. 3 and 4, the second support section 10 has a through hole 13 for the first support section 9 to movably pass through, and an inner diameter of the through hole 13 is greater than an outer diameter of the first support section 9. Since the first support section 9 always moves relative to the second support section 10, the through hole 13 provides space for the movement of the first support section 9, does not limit the vibration (swinging motion) of the first support section 9, and also provides some radial space to ensure the smooth vibration of the first support section 9.

In an embodiment, when the first support section 9 is assembled with the vibrating toothbrush head 7, there is at least a gap in the transverse direction between the second support section 10 and the vibrating toothbrush head 7. As shown in FIG. 8, there is also a gap 12 in the frontward/rearward direction between the second support section 10 and the vibrating toothbrush head 7. A brush rod of the vibrating toothbrush head 7 itself can be an integral structure, and two ends of the vibrating toothbrush head 7 often have a large shaking amplitude during vibration. These gaps can avoid an interference between the second support section 10 and the vibrating toothbrush head 7 during vibration, so as to ensure the smoothness and stability of vibration.

As shown in FIGS. 3 and 4, in an embodiment, the first support section 9 includes a flattened section. An outer wall of the flattened section includes a convex curved surface 94 and a flattened plane 91. The flattened plane 91 is parallel to the length direction of the first support section 9 (corresponding to the X direction in the drawings). A cross-sectional profile of the flattened section can be D-shaped, that is, a bow shape including a semicircle. A female buckle 92 for snap-fitting with the vibrating toothbrush head 7 is recessed on the convex curved surface 94.

The first support section 9 is not a regular cylinder, and a special cross-sectional shape of the first support section 9 is able to limit a rotation and loosening tendency of the tenon around its own axis after being assembled with the toothbrush head.

As shown in FIGS. 3 and 4, in an embodiment, a top end of the first support section 9, that is, a top end of the tenon, has a chamfer 93, which is able to reduce an alignment accuracy requirement when the tenon is assembled with different toothbrush heads.

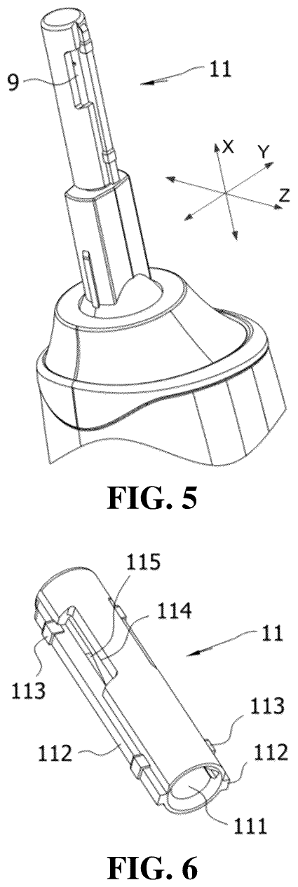

As shown in FIGS. 5, 6, 7, and 8 in an embodiment, a sleeve 11 is arranged between the first support section 9 and the vibrating toothbrush head 7. An outer wall of the sleeve 11 has convex rib(s) 112, and a length direction of the convex rib 112 (corresponding to the X direction in the drawings) is parallel to an axial direction of the sleeve 11 (corresponding to the X direction in the drawings). The convex rib 112 has protrusion(s) 113, and a top end of the protrusion 113 is in interference fit with the vibrating toothbrush head 7.

The sleeve 11 facilitates changing an outer contour shape of the first support section 9 in the tenon to facilitate the assembly with the specific vibrating toothbrush head 7.

As shown in FIG. 6, a pair of convex ribs 112 are distributed on two sides of the sleeve 11 in mirror symmetry, and each convex rib 112 has two protrusions 113, which is equivalent to having four protrusions 113 participate in the interference fit. Cross-sectional profiles of the convex rib 112 and the protrusion 113 can be rectangular.

An inner wall of the vibrating toothbrush head 7 is provided with two clamping grooves. By designing a distance between the two clamping grooves to be slightly less than a width between the two convex ribs 112 of the sleeve 11, when the vibrating toothbrush head 7 is mounted, the clamping grooves need to expand moderately outward to adapt to a width of the tenon fitted with the sleeve 11. This design ensures a tight contact between the vibrating toothbrush head 7 and the tenon, thereby making the vibrating toothbrush head 7 more stable during use and reducing a risk of loosening or falling off.

As shown in FIG. 6, in an embodiment, an end of the sleeve 11 has an assembly hole 111 for the first support section 9 to enter. As shown in FIG. 8, a first male buckle 116 protrudes from an inner wall of the assembly hole 111, and the first male buckle 116 can be snap-fitted with the female buckle 92. As shown in FIGS. 6 and 8, a sloping platform 115 further protrudes from the inner wall of the assembly hole 111, and the sloping platform 115 can contact the flattened plane 91. A slope of the sloping platform 115 faces an opening direction of the assembly hole 111, and the slope of the sloping platform 115 guides the tenon to move slightly in the frontward/rearward direction. Finally, a top of the sloping platform 115 abuts against the flattened plane 91 of the tenon, so as to achieve the effect of firmly assembling the first male buckle 116 with the female buckle 92.

As shown in FIG. 6, in an embodiment, the sleeve 11 has a window hole 114 penetrating inside and outside. The window hole 114 helps to break a blind hole feature of the assembly hole 111, facilitating the first support section 9 to smoothly enter the assembly hole 111.

As shown in FIGS. 3 and 4, in an embodiment, an outer wall of the second support section 10 includes a plurality of abutting portions 102 protruding outward. The abutting portions 102 are arranged in mirror symmetry or in a circular array around a central line of the second support section 10. The abutting portions 102 are in interference fit with the rotating toothbrush head 8. The abutting portions 102 are configured to limit the shaking of the rotating toothbrush head 8, thereby improving the stability during use.

A length direction of the abutting portions 102 (corresponding to the X direction in the drawings) can be parallel to a length direction of the second support section 10 (corresponding to the X direction in the drawings). An end of the abutting portion 102 facing the first support section 9 can have a chamfer for facilitating the assembly of the second support section 10 and the rotating toothbrush head 8. The outer wall of the second support section 10 further has inwardly contracting surfaces 101 that are radially inwardly contracted at positions without the abutting portions 102. There can be two inwardly contracting surfaces 101 and two abutting portions 102, and a transverse distance between the pair of inwardly contracting surfaces 101 is less than a transverse distance between the pair of abutting portions 102. The inwardly contracting surfaces 101 do not contact the rotating toothbrush head 8. In a non-limiting example, a direction of a connecting line between the pair of abutting portions 102 is perpendicular to the flattened plane 91.

The second support section 10 can be an injection-molded member. The second support section 10 can be an injection-molded member integrally formed with a main body of the toothbrush handle, that is, to ensure that the brush rod shell 83 of the rotating toothbrush head 8 after mounting and the main body of the toothbrush handle are relatively fixed.

As shown in FIG. 9, in an embodiment, a second male buckle 84 protrudes from a surface of the connecting rod 81 of the rotating toothbrush head 8, and the second male buckle 84 can be snap-fitted with the female buckle 92. In this way, the connecting rod 81 can move synchronously with the first support section 9.

In addition, as shown in FIG. 9, a third male buckle 104 can protrude from a side of the second support section 10. Moreover, the brush rod shell 83 has a positioning hole 85. The third male buckle 104 can be snap-fitted with the positioning hole 85. The third male buckle 104 and the positioning hole 85 can provide a more secure ability of positional limitation. Whether it is the snap fit between the first male buckle 116 and the female buckle 92, the snap fit between the second male buckle 84 and the female buckle 92, or the snap fit between the third male buckle 104 and the positioning hole 85, they all belong to mechanical locking, and the mechanical locking can prevent the toothbrush head from rotating or loosening during use. In particular, when mounting the vibrating toothbrush head 7 or the rotating toothbrush head 8, a user has an obvious feeling of jamming to remind the user that the toothbrush head has been correctly mounted in place. The third male buckle 104 is equivalent to a supplement to the function of the abutting portions 102.

In an embodiment, an identification point is arranged on the tenon, and the identification point is able to identify whether the tenon is assembled with the vibrating toothbrush head 7 or the rotating toothbrush head 8. The identification principles of the identification point include but are not limited to physical contact point identification, circuit connection identification, radio frequency tag identification (RFID tag identification), optical identification, and near field communication (NFC) identification. The principle of radio frequency tag identification is that a reader and a tag carry out a non-contact data communication to achieve the purpose of identifying a target, that is, the tenon and the toothbrush head can be respectively provided with the reader and the tag at specified positions. Near field communication identification is developed on the basis of non-contact radio frequency identification technology combined with wireless interconnection technology, and near field refers to radio waves that are adjacent to an electromagnetic field. The identification point can be arranged on the flattened plane 91, which has a relatively sufficient plane for arrangement. Specifically, an identification point with a certain principle can be selected according to actual needs.

As shown in FIG. 7, an outer surface of the toothbrush handle is wrapped by a handle housing 6. In a direction toward the toothbrush head, a bottom cover assembly 1, a battery 2, and a motor 5 are sequentially arranged in the handle housing 6. A PCB board 3 is arranged on a same side of the battery 2 and the motor 5, and the PCB board 3 is located inside the handle housing 6. The PCB board 3 is also covered with a light-shielding member 4, and the light-shielding member 4 is convenient for forming a hidden panel.

The motor 5 is connected to a power rod. The power rod passes through the second support section 10, and a portion of the power rod exposed from an end of the second support section 10 is the first support section 9 of the tenon. Here, a portion of the power rod connected to the first support section 9 and located inside the second support section 10 can be called the base end of the first support section 9. The motor 5 at least has the function of driving the power rod to vibrate.

In a non-limiting example, a vibration frequency of the motor or a component driven by the motor can be in a range of 40 Hz to 450 Hz, a corresponding vibration frequency of the vibrating toothbrush head can be in a range of 150 Hz to 450 Hz, and a corresponding vibration frequency of the rotating toothbrush head can be in a range of 40 Hz to 150 Hz. The frequency of the electric toothbrush can be adjusted to select whether to work in a vibration mode or in a rotation mode.

An operation mode of the electric toothbrush according to a first embodiment of the present disclosure is as follows.

In step S101, the vibrating toothbrush head 7 is mounted. The user mounts the vibrating toothbrush head 7 on the tenon of the toothbrush handle. The vibrating toothbrush head 7 is closely fitted with the first support section 9 through the interference fit. In step S102, the type of the brush head is identified. Since the identification point is designed on the tenon, the toothbrush handle is able to identify the type of the mounted brush head. In step S103, a signal is transmitted. After identifying the vibrating toothbrush head 7, the tenon sends a first signal to a control system inside the toothbrush handle. In step S104, a mode adjustment is performed. After receiving the first signal, the control system adjusts the working mode of the electric toothbrush to adapt to the needs of the vibrating toothbrush head 7. The control system sets appropriate parameters such as speed, angle, and torque to ensure the best cleaning effect. In step S105, the electric toothbrush is started. The user presses a start button of the electric toothbrush, the electric toothbrush starts to work, and the control system drives the motor 5 to operate in a set state according to the previously adjusted mode.

An operation mode of the electric toothbrush according to another embodiment of the present disclosure is as follows.

In step S201, the rotating toothbrush head 8 is mounted. The user mounts the rotating toothbrush head 8 on the tenon of the toothbrush handle. Different parts of the rotating toothbrush head 8 are closely fitted with the second support section 10 and the first support section 9 respectively. In step S202, the type of the brush head is identified. Since the identification point is designed on the tenon, the toothbrush handle is able to identify the type of the mounted brush head. In step S203, a signal is transmitted. After identifying the rotating toothbrush head 8, the tenon sends a second signal to the control system inside the toothbrush handle. In step S204, a mode adjustment is performed. After receiving the second signal, the control system adjusts the working mode of the electric toothbrush to adapt to the needs of the rotating toothbrush head 8. The control system sets appropriate parameters such as speed, angle, and torque to ensure the best cleaning effect. In step S205, the electric toothbrush is started. The user presses the start button of the electric toothbrush, the electric toothbrush starts to work, and the control system drives the motor to operate in a set rotation mode according to the previously adjusted mode.

The above embodiments are only intended to illustrate the technical concept and characteristics of the present disclosure, and their purpose is to enable those familiar with the technology to understand the content of the present disclosure and implement it. They should not be used to limit the protection scope of the present disclosure. All equivalent changes or modifications made according to the spirit of the present disclosure should be covered in the protection scope of the present disclosure.

What is claimed is:

1. An electric toothbrush, comprising:
a toothbrush handle, wherein a tenon protrudes from an end of the toothbrush handle, and the tenon comprises a first support section and a second support section; the second support section surrounds a base end of the first support section, and the first support section is able to move relative to the second support section; and a motor for driving the first support section to move is provided inside the toothbrush handle; and
toothbrush heads comprising a vibrating toothbrush head and a rotating toothbrush head, wherein the first support section is able to be assembled with the vibrating toothbrush head, so that the motor is able to drive the vibrating toothbrush head to vibrate via the first support section; and the first support section and the second support section are able to be assembled with the rotating toothbrush head, so that the motor is able to drive bristles of the rotating toothbrush head to rotate via the first support section.

2. The electric toothbrush according to claim 1, wherein the first support section is able to be in interference fit with the vibrating toothbrush head and the rotating toothbrush head.

3. The electric toothbrush according to claim 1, wherein
the rotating toothbrush head comprises a brush rod shell and a circular brush head, a connecting rod is comprised inside the brush rod shell, and the connecting rod and the circular brush head form a crank-rocker mechanism.

4. The electric toothbrush according to claim 1, wherein the first support section is closer to a top end of the toothbrush handle than the second support section; and
the second support section has a through hole for the first support section to movably pass through, and an inner diameter of the through hole is greater than an outer diameter of the first support section.

5. The electric toothbrush according to claim 1, wherein the vibrating toothbrush head is able to vibrate in a transverse direction of the electric toothbrush; and when the first support section is assembled with the vibrating toothbrush head, at least a gap is provided in the transverse direction between the second support section and the vibrating toothbrush head.

6. The electric toothbrush according to claim 3, wherein the first support section comprises a flattened section, an outer wall of the flattened section comprises a convex curved surface and a flattened plane, and the flattened plane is parallel to a length direction of the first support section; and
a female buckle for snap-fitting with the vibrating toothbrush head or the rotating toothbrush head is recessed on the convex curved surface.

7. The electric toothbrush according to claim 6, wherein a sleeve is arranged between the first support section and the vibrating toothbrush head, an outer wall of the sleeve has a convex rib, and a length direction of the convex rib is parallel to an axial direction of the sleeve; and the convex rib has a protrusion, and a top end of the protrusion is in interference fit with the vibrating toothbrush head.

8. The electric toothbrush according to claim 7, wherein the sleeve has an assembly hole for the first support section to enter, a first male buckle protrudes from an inner wall of the assembly hole, and the first male buckle is able to be snap-fitted with the female buckle; and
a sloping platform further protrudes from the inner wall of the assembly hole, and the sloping platform is able to be in contact with the flattened plane.

9. The electric toothbrush according to claim 1, wherein an outer wall of the second support section comprises a plurality of abutting portions protruding outward, the abutting portions are arranged in mirror symmetry or in a circular array around a central line of the second support section, and the abutting portions are in interference fit with the rotating toothbrush head.

10. The electric toothbrush according to claim 6, wherein the connecting rod comprises a second male buckle, and the second male buckle is able to be snap-fitted with the female buckle.

11. The electric toothbrush according to claim 1, wherein an identification point is provided on the tenon, and the identification point is able to identify and distinguish whether the tenon is assembled with the vibrating toothbrush head or the rotating toothbrush head; and the identification point uses physical contact point identification, circuit connection identification, radio frequency tag identification, optical identification or near field communication identification.

12. The electric toothbrush according to claim 1, wherein the first support section is able to be in snap fit with the vibrating toothbrush head and the rotating toothbrush head.

13. The electric toothbrush according to claim 1, wherein the second support section is able to be in clearance fit with the vibrating toothbrush head, and to be in interference fit with the rotating toothbrush head.

14. The electric toothbrush according to claim 1, wherein the second support section is able to be in clearance fit with the vibrating toothbrush head, and to be in snap fit with the rotating toothbrush head.
